(19) United States
(12) Patent Application Publication
(10) Pub. No.: US 2021/0255874 A1
(43) Pub. Date: Aug. 19, 2021

(54) ACCELERATED SYSTEM BOOT

(71) Applicant: Dell Products L.P., Round Rock, TX (US)

(72) Inventors: Balasingh P. SAMUEL, Round Rock, TX (US); Anand Prakash JOSHI, Round Rock, TX (US)

(73) Assignee: Dell Products L.P., Round Rock, TX (US)

(21) Appl. No.: 16/790,267

(22) Filed: Feb. 13, 2020

(51) Int. Cl. G06F 9/4401; G06F 8/65

(52) U.S. Cl. CPC G06F 9/4406; G06F 8/65

(57) ABSTRACT

An information handling system may include at least one processor, and a computer-readable medium having instructions thereon that are executable by the at least one processor. The instructions may be executable for: in response to detection of a first trigger event, enabling an accelerated boot process; and in response to detection of a second, different trigger event, enabling a non-accelerated boot process. The non-accelerated boot process may include parsing an internal forms representation (IFR), and the accelerated boot process may include not parsing the IFR.

### TECHNICAL FIELD

The present disclosure relates in general to information handling systems, and more particularly to accelerating the boot process for information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Even as processing power grows, it is a known problem in the industry that boot times continue to increase. This phenomenon may be driven in part by growing pre-boot feature sets and options. For example, increasing numbers of options are becoming available in the Unified Extensible Firmware Interface (UEFI) Basic Input/Output System (BIOS) pre-boot environments.

It is to be noted that various terms discussed herein are described in the UEFI Specification Version 2.8, released March 2019 (hereinafter, UEFI Specification), which is hereby incorporated by reference in its entirety. One of ordinary skill in the art with the benefit of this disclosure will understand its applicability to other specifications (e.g., prior or successor versions of the UEFI Specification). Further, some embodiments may be applicable to different technologies other than UEFI.

The increasing number of pre-boot setup options may increase the processing time required to parse the Internal Forms Representation (IFR) of a UEFI BIOS, which is typically a binary format used for encoding the options that are to be presented to a user. For example, the processing time for parsing the IFR may be on the order of ½ second, which is added to the boot process. However, in accordance with embodiments of this disclosure, that time may be reduced or eliminated under certain conditions.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with accelerating the boot process for information handling systems may be reduced or eliminated.

In accordance with embodiments of the present disclosure, an information handling system may include at least one processor, and a computer-readable medium having instructions thereon that are executable by the at least one processor. The instructions may be executable for: in response to detection of a first trigger event, enabling an accelerated boot process; and in response to detection of a second, different trigger event, enabling a non-accelerated boot process. The non-accelerated boot process may include parsing an internal forms representation (IFR), and the accelerated boot process may include not parsing the IFR.

In accordance with these and other embodiments of the present disclosure, a method may include an information handling system enabling an accelerated boot process in response to detection of a first trigger event, and the information handling system enabling a non-accelerated boot process in response to detection of a second, different trigger event. The non-accelerated boot process may include parsing an internal forms representation (IFR), and the accelerated boot process may include not parsing the IFR.

In accordance with these and other embodiments of the present disclosure, an article of manufacture may include a non-transitory, computer-readable medium having computer-executable code thereon that is executable by a processor of an information handling system. The code may be executable for: in response to detection of a first trigger event, enabling an accelerated boot process for the information handling system, and, in response to detection of a second, different trigger event, enabling a non-accelerated boot process for the information handling system. The non-accelerated boot process may include parsing an internal forms representation (IFR), and the accelerated boot process may include not parsing the IFR.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a flow chart of a method, in accordance with embodiments of the present disclosure.

### DETAILED DESCRIPTION

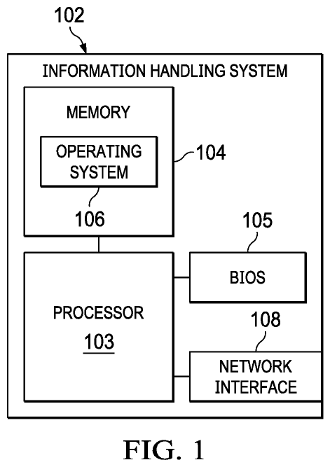

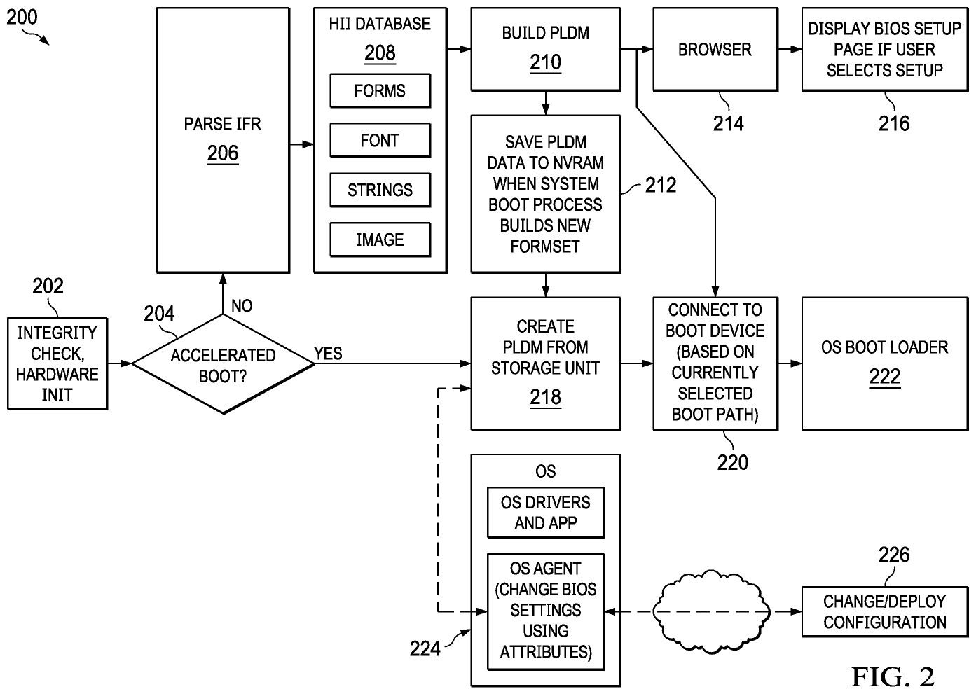

Preferred embodiments and their advantages are best understood by reference to FIGS. 1 through 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

As discussed above, embodiments of this disclosure may eliminate the need for IFR processing under certain circumstances, which may decrease the amount of time needed for system boot. As one of ordinary skill in the art with the benefit of this disclosure will understand, the IFR is an encoding of forms that are used in presenting a user interface during a pre-boot phase. For example, a high-level visual forms representation (VFR) may be created by designers, and this may be translated into the IFR by the firmware build process. The IFR may then be flashed to the BIOS along with other components.

Embodiments of this disclosure may provide for multiple boot flow paths, allowing for the boot time during an accelerated boot process (which may in practice occur in most boots) to be decreased. As discussed below, in the relatively uncommon non-accelerated path for the boot process, the IFR may be parsed/processed to create a Platform Level Data Model (PLDM) database, and/or a Human Interface Infrastructure (HII) database with strings, and/or form sets and images required for a pre-boot setup browser. In some embodiments, the accelerated boot process may skip the IFR processing and HII database generation. In some embodiments, the accelerated boot process may generate a PLDM database from previously stored data (e.g., stored in a non-volatile storage element such as NVRAM). Thus, in-band and/or out-of-band management software may continue to be able to change configurations to support OS-level BIOS setup applications as well deployment tools managed by IT administrators.

Turning now to FIG. 2, a flow chart of an example method 200 for accelerated system boot is shown, in accordance with some embodiments. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, an information handling system may be powered on, and the initial integrity checking and hardware initialization may take place. At step 204, a determination may be made as to whether the system should enable an accelerated boot process or a non-accelerated boot process. This determination may be stored in a BIOS indicator flag, which may be updated both in the pre-boot phase and/or during the later runtime phase.

Many different factors may be taken into account at step 204. For example, the presence of certain trigger events may cause the accelerated boot to be enabled. The presence of different trigger events may cause the non-accelerated boot to be enabled. In some instances, no trigger event may occur, in which case a default boot (e.g., an accelerated boot) may occur.

For example, trigger events that may cause an accelerated boot may include one or more of the following:

1. Detection of a system password (e.g., an administrator password protecting access to the pre-boot environment). In this situation, the end user may be unable to change (or in some cases even to view) the BIOS settings, and so there is no benefit to parsing the IFR and generating HII and PLDM databases during the boot process.

2. After one or more successful boots. For example, detection that N (e.g., 3) consecutive previous boots have been successful may trigger an accelerated boot.

3. An administrator policy setting to indicate that accelerated boot process is desired, or that end users are not allowed to change BIOS settings.

4. A scheduled flash update and/or firmware recovery phase. During the flash update process, it may be preferred to skip the IFR parsing process, as the end user may be prevented from interacting with the system anyway.

Conversely, other types of trigger events may cause a non-accelerated boot to occur. For example:

1. After a flash update process or firmware recovery process, the first boot may require re-parsing the IFR.

2. After an unsuccessful (or incomplete) boot.

3. A special sequence (e.g., involving one or more key presses), which may be detected by an embedded controller of the system. The embedded controller may notify the system BIOS to parse the IFR and rebuild any databases needed by the setup browser. For example, a sequence such as: unplug the power, hold Ctrl+F1 keys, plug in the power, then release the Ctrl+F1 keys to force IFR parsing (and optionally to go directly to the BIOS setup page). Other sequences may include repeatedly tapping the power button, etc.

4. Detection of a critical change in the system environment by an embedded controller.

5. Detection of a changed setup configuration (either via the setup browser or remotely).

6. Detection of an OS bug check event.

7. The first boot after a diagnostic check (e.g., an onboard diagnostic or an OS-level diagnostic) has been performed.

8. An administrator policy setting to indicate that a non-accelerated boot process is desired.

In some embodiments, the presence of any single trigger event (e.g., any of the example triggers mentioned above) may immediately determine the result at step 204. In other embodiments, factors may be combined in various ways. For example, even if one trigger event is present that would ordinarily cause an accelerated boot, the simultaneous presence of one or more countervailing factors may cause a non-accelerated boot. One of ordinary skill with the benefit of this disclosure will readily appreciate the many ways in which trigger event factors may be combined as desired in any particular embodiment.

If a non-accelerated boot is determined at step 204, then the method may proceed to step 206, and the IFR may be parsed. This process may generate an HII database at step 208, which may include any forms, strings, fonts, and images needed for the pre-boot browser.

At step 210, the PLDM may be built. The PLDM data may also be saved to NVRAM at step 212, so that it may be re-used during some subsequent (accelerated) boot process.

At steps 214 and 216, if needed, the pre-boot browser may be invoked, and the BIOS setup page may be presented to the user.

On the other hand, if an accelerated boot is determined at step 204, the method may instead proceed to step 218. At step 218, the PLDM may be created from the cached copy generated during steps 210 and 212 of a previous (non-accelerated) boot process.

In both the accelerated and non-accelerated boot processes, the method eventually proceeds to step 220, in which the BIOS connects to a designated boot device (e.g., a hard drive, USB drive, network boot, etc.). The OS boot loader then executes at step 222.

As also indicated in FIG. 2, once the OS has been loaded at step 224, BIOS changes may be performed at runtime via the use of an OS agent program. A user or administrator may make such changes remotely in some embodiments by changing or deploying configurations over a network connection at step 226.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102 and/or any other system operable to implement method 200. In certain embodiments, method 200 may be implemented partially or fully in software and/or firmware embodied in computer-readable media.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a computer-readable medium having instructions thereon that are executable by the at least one processor for:
in response to detection of a first trigger event, enabling an accelerated boot process; and
in response to detection of a second, different trigger event, enabling a non-accelerated boot process;
wherein the non-accelerated boot process includes parsing an internal forms representation (IFR), and wherein the accelerated boot process does not include parsing the IFR.

2. The information handling system of claim 1, wherein the non-accelerated boot process further includes parsing the IFR to generate a platform level data model (PLDM) database.

3. The information handling system of claim 1, wherein the computer-readable medium includes a Basic Input/Output System (BIOS).

4. The information handling system of claim 3, wherein the BIOS comprises a Unified Extensible Firmware Interface (UEFI) BIOS.

5. The information handling system of claim 4, wherein the IFR is compatible with a binary format defined by a UEFI Specification.

6. The information handling system of claim 1, wherein the instructions are further executable for, in response to not detecting either the first trigger event or the second trigger event, enabling the accelerated boot process as a default boot process.

7. The information handling system of claim 1, wherein the first trigger event includes at least one event selected from the group consisting of:
presence of a system password;
a predetermined number of prior successful boot events;
an administrator policy setting; and
a scheduled firmware update event.

8. The information handling system of claim 1, wherein the second trigger event includes at least one event selected from the group consisting of:
a completed firmware update event;
a prior unsuccessful boot event;
a predetermined key sequence;
a particular system configuration change;
an operating system bug check event; and
a first system startup subsequent to a diagnostics event.

9. A method comprising:
an information handling system enabling an accelerated boot process in response to detection of a first trigger event; and
the information handling system enabling a non-accelerated boot process in response to detection of a second, different trigger event;
wherein the non-accelerated boot process includes parsing an internal forms representation (IFR), and wherein the accelerated boot process does not include parsing the IFR.

10. The method of claim 9, wherein:
the method is implemented via computer-executable instruction stored in a Unified Extensible Firmware Interface (UEFI) Basic Input/Output System (BIOS) of the information handling system; and
the IFR is compatible with a binary format defined by a UEFI Specification.

11. The method of claim 9, wherein the first trigger event includes at least one event selected from the group consisting of:
presence of a system password;
a predetermined number of prior successful boot events;
an administrator policy setting; and
a scheduled firmware update event.

12. The method of claim 9, wherein the second trigger event includes at least one event selected from the group consisting of:
a completed firmware update event;
a prior unsuccessful boot event;
a predetermined key sequence;
a particular system configuration change;
an operating system bug check event; and
a first system startup subsequent to a diagnostics event.

13. An article of manufacture comprising a non-transitory, computer-readable medium having computer-executable code thereon that is executable by a processor of an information handling system for:
in response to detection of a first trigger event, enabling an accelerated boot process for the information handling system; and
in response to detection of a second, different trigger event, enabling a non-accelerated boot process for the information handling system;
wherein the non-accelerated boot process includes parsing an internal forms representation (IFR), and wherein the accelerated boot process does not include parsing the IFR.

14. The article of claim 13, wherein the non-accelerated boot process further includes parsing the IFR to generate a platform level data model (PLDM) database.

15. The article of claim 13, wherein the computer-readable medium includes a Basic Input/Output System (BIOS).

16. The article of claim 15, wherein the BIOS comprises a Unified Extensible Firmware Interface (UEFI) BIOS.

17. The article of claim 16, wherein the IFR is compatible with a binary format defined by a UEFI Specification.

18. The article of claim 13, wherein the computer-executable code is further for, in response to not detecting either the first trigger event or the second trigger event, enabling the accelerated boot process as a default boot process.

19. The article of claim 13, wherein the first trigger event includes at least one event selected from the group consisting of:
presence of a system password;
a predetermined number of prior successful boot events;
an administrator policy setting; and
a scheduled firmware update event.

20. The article of claim 13, wherein the second trigger event includes at least one event selected from the group consisting of:
a completed firmware update event;
a prior unsuccessful boot event;
a predetermined key sequence;
a particular system configuration change;
an operating system bug check event; and
a first system startup subsequent to a diagnostics event.
